(19) United States
(12) Patent Application Publication
(10) Pub. No.: US 2016/0303595 A1
(43) Pub. Date: Oct. 20, 2016

(54) COLOR CODING RING FOR SPRAY GUNS

(71) Applicant: 3M INNOVATIVE PROPERTIES COMPANY, St. Paul, MN (US)

(72) Inventors: Brian E. Duncan, St. Paul, MN (US); Eric O. Nyaribo, Woodbury, MN (US); John I. Escoto, JR., Houston, TX (US)

(21) Appl. No.: 15/102,067

(22) PCT Filed: Dec. 2, 2014
(86) PCT No.: PCT/US2014/068060

§ 371 Date: Jun. 6, 2016

Related U.S. Application Data
(60) Provisional application No. 61/914,454, filed on Dec. 11, 2013.

(51) Int. Cl. B05B 9/01; G09F 3/02; B05B 7/12

(52) U.S. Cl. CPC B05B 9/01; B05B 7/12; G09F 3/02

(57) ABSTRACT

A spray gun (10) comprising a rotatable control knob (100) is disclosed. The rotatable control knob (100) comprises a gripping surface (110) at least partially surrounding a rotation axis (101), an attachment end (104) disposed along the rotation axis (101) for rotatable connection of the control knob (100) to the spray gun (10), an indicator retaining feature (120) on the gripping surface extending in a retaining feature trajectory about the rotation axis from a first retainer end (140) to a second retainer end (150), and a gripping surface position indicator (200) separating the first retainer end from the second retainer end. The gripping surface position indicator indicates the rotational position of the control knob about the rotation axis. Also disclosed are indicators to be retained by the indicator retaining feature.

### BACKGROUND

Spray guns are commonly used to apply coatings in many fields. In some fields, such as vehicle collision repair, painters may use multiple spray guns for different jobs, or even for single job. For example, a painter may need to apply a primer coat, a base coat, and a clear coat to complete a single repair. These different steps may require spray guns having, for example, different sizes of spray orifice to accommodate coatings of differing viscosity. Moreover, more than one painter may work in the same area. There is a need to provide identification of spray guns to identify their intended use and/or user.

### SUMMARY OF THE INVENTION

Exemplary embodiments according to the present disclosure include, but are not limited to, the embodiments listed below, which may or may not be numbered for convenience. Several additional embodiments, not specifically enumerated in this section, are disclosed within the accompanying detailed description.

Embodiments according to the present disclosure can facilitate easy identification of a spray gun. Moreover, embodiments according to the present disclosure can enhance the visual cues given to the user to view the position of a rotatable control knob.

### Embodiment 1

A spray gun comprising a rotatable control knob, the rotatable control knob comprising:
a gripping surface at least partially surrounding a rotation axis;
an attachment end disposed along the rotation axis for rotatable connection of the control knob to the spray gun;
an indicator retaining feature on the gripping surface extending in a retaining feature trajectory about the rotation axis from a first retainer end to a second retainer end; and
a gripping surface position indicator separating the first retainer end from the second retainer end, the gripping surface position indicator indicating the rotational position of the control knob about the rotation axis.

### Embodiment 2

The spray gun of Embodiment 1, wherein the gripping surface position indicator spans an angle α about the rotation axis, wherein α is in a range from about 5 degrees to about 90 degrees.

### Embodiment 3

The spray gun of any of Embodiments 1-2 wherein the retaining feature is recessed in the gripping surface.

### Embodiment 4

The spray gun of any of Embodiments 1-2 wherein the retaining feature is proud of the gripping surface.

### Embodiment 5

The spray gun of any of Embodiments 1-4 further comprising a face surface disposed along the rotation axis opposite the attachment end; and a face surface position indicator aligned with the gripping surface position indicator.

### Embodiment 6

The spray gun of any of Embodiments 1-5 wherein the gripping surface is generally cylindrical.

### Embodiment 7

The spray gun of any of Embodiments 1-6 wherein the retaining feature trajectory sweeps an incomplete portion of a circular path, wherein the remaining portion of the circular path comprises the gripping surface position indicator.

### Embodiment 8

The spray gun according to any of the preceding Embodiments comprising an indicator retained by the indicator retaining feature.

### Embodiment 9

The spray gun of Embodiment 8 wherein the indicator is retained by the indicator retaining feature such that the indicator is retained against rotation with respect to the rotatable control knob.

### Embodiment 10

The spray gun of any of Embodiments 8-9 wherein the indicator comprises a color selected from a set of colors to color-code the spray gun.

### Embodiment 11

The spray gun of any of Embodiments 8-10 wherein the indicator comprises an indicator trajectory that corresponds to the retaining feature trajectory.

### Embodiments 12

The spray gun of any of Embodiments 8-11 wherein the indicator comprises a first indicator end and a second indicator end connected by an indicator body portion, and separated from one another by the gripping surface position indicator.

### Embodiment 13

The spray gun of Embodiment 12 wherein the first indicator end is positioned proximate the first retainer end, and the second indicator end is positioned proximate the second retainer end.

### Embodiment 14

A kit comprising a spray gun according to any of Embodiments 1-7 and one or more indicators adapted to be retained by the indicator retainer feature.

### Embodiment 15

The kit of Embodiment 14 comprising a plurality of indicators of different colors to enable a user to color-code the spray gun.

The words “preferred” and “preferably” refer to embodiments described herein that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the terms “comprises” and variations thereof do not have a limiting meaning where these terms appear in the accompanying description. Moreover, “a,” “an,” “the,” “at least one,” and “one or more” are used interchangeably herein.

Relative terms such as left, right, forward, rearward, top, bottom, side, upper, lower, horizontal, vertical, and the like may be used herein and, if so, are from the perspective observed in the particular figure. These terms are used only to simplify the description, however, and not to limit the scope of the invention in any way.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

As used herein, the symbol ° may be used interchangeably with the word “degrees” to describe an angle.

The above summary is not intended to describe each embodiment or every implementation of the reservoirs and associated vent assemblies described herein. Rather, a more complete understanding of the invention will become apparent and appreciated by reference to the following Description of Illustrative Embodiments and claims in view of the accompanying figures of the drawing.

These and other aspects of the invention will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 depicts a spray gun and/or a kit in a partially exploded state according to the present disclosure;

FIG. 2 depicts an isometric view of a rotatable control knob comprising an indicator according to the present disclosure;

FIG. 3 depicts a side view of the assembly of FIG. 2;

FIG. 4 depicts a cross-section view taken at 4-4 of the assembly of FIG. 2;

FIG. 5 depicts a, exploded view of the assembly of FIG. 2; and

FIGS. 6-9 depict exemplary alternative shapes for rotatable control knobs and trajectories for indicator retaining features and indicators according to the present disclosure.

### DETAILED DESCRIPTION

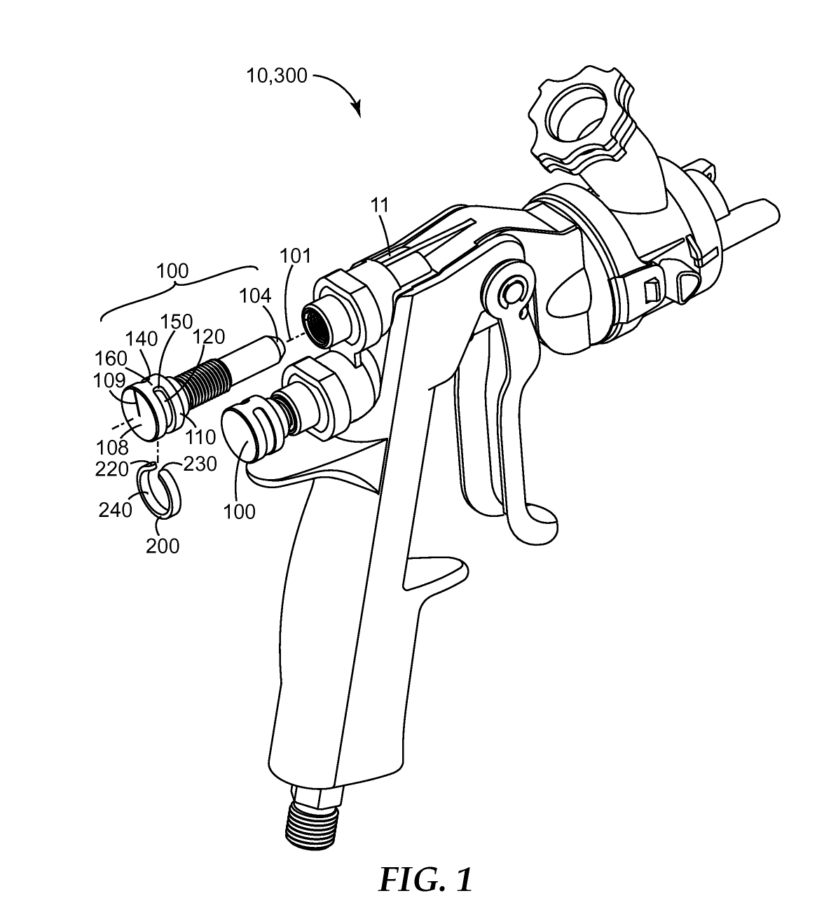

Referring now to FIG. 1, an exemplary spray gun 10 according to the present disclosure is shown. While the spray gun 10 depicted is a gravity-fed spray gun 10 featuring a removable spray nozzle assembly, the present disclosure is applicable to any spray gun 10 having one or more rotatable control knobs, including, for example, gravity-fed, siphon-fed, HVLP, compliant, airless, and air-assisted spray guns. Moreover, spray guns according to the present disclosure may be used to spray or apply (i.e., as in applying a bead with no atomization) any fluid, such as paints, stains, adhesives, sealants, or other coatings.

The spray gun 10 comprises on or more rotatable control knobs that are used to adjust settings on the spray gun 10. For example, a rotatable control knob 100 may be used to adjust a valve to regulate air (or other gas) or fluid flow through the spray gun 10. A rotatable control knob 100 may also be used to adjust the travel of a trigger on the spray gun 10. Typically (though not necessarily), the rotatable control knob 100 comprises a thread to permit the rotatable control knob 100 to translate into and out of the spray gun body 11 while rotating about the rotation axis 101.

Rotatable control knobs according to the present disclosure may be formed of any material, and by any process, suitable for carrying out the intended function. In one embodiment, the rotatable control knob 100 is machined from a piece of metal such as stainless steel. Durable and non-reactive materials such as stainless steel are often desirable in applications and environments where spray guns are used. For example, stainless steel is resistant to the solvents often used to thin and clean automotive paints.

The spray gun 10 shown in FIG. 1 comprises two rotatable control knobs. One rotatable control knob 100 is shown in an assembled state, while the other is shown in an exploded state to clarify the relation of the various parts to one another, and the manner in which they may be assembled into the spray gun body 11. In the embodiment shown, the upper rotatable control knob 100 (shown exploded) controls the ratio of air directed into the spray nozzle for shaping and atomizing, respectively. Meanwhile, the lower rotatable control knob 100 controls the travel of the trigger mechanism, and therefore the fluid needle (not shown). Either or both of the rotatable control knobs may comprise indicator 200 features as described herein.

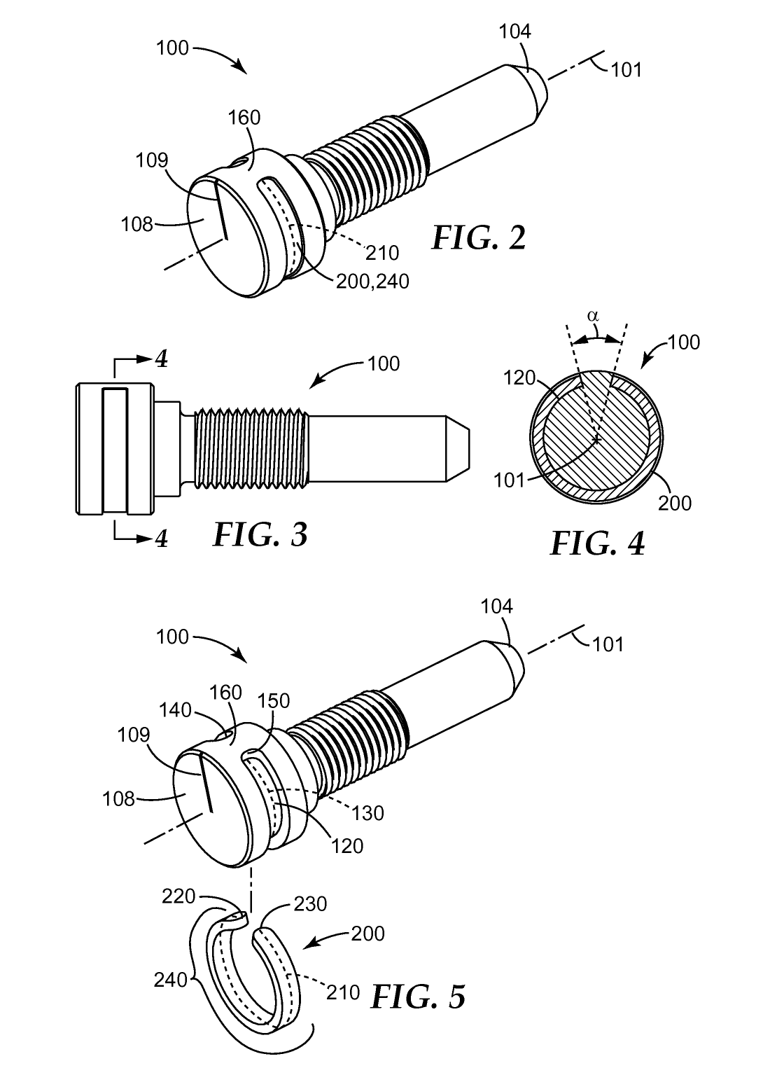

Turning now to FIGS. 2-5, an exemplary rotatable control knob 100 is shown isolated from a spray gun body 11 for convenience. The rotatable control knob 100 comprises a rotation axis 101, an attachment end 104 for assembly with the spray gun body 11, and a face surface 108 opposite the attachment end 104. The face surface 108 may comprise a face surface position indicator 109 to indicate to the user the angular position of the rotatable control knob 100. In the exemplary embodiment shown, the face surface 108 is proximate a gripping surface 110 adapted to facilitate gripping and turning the rotatable control knob 100 by a user's fingers. The gripping surface 110 may optionally comprise knurling or similar to increase grip.

As shown, the gripping surface 110 comprises an indicator retaining feature 120. The indicator retaining feature 120 is swept in a retaining feature trajectory 130 about the rotation axis 101 from a first retainer end 140 to a second retainer end 150. An indicator 200 is retained by the indicator retaining feature 120. The indicator 200 comprises an indicator trajectory 210. The indicator 200 comprises an indicator body portion 240 that is swept along the indicator trajectory 210 from a first indicator end 220 to a second indicator end 230.

In the exemplary embodiment shown, the indicator trajectory 210 corresponds to the retaining feature trajectory 130 such that the indicator 200 can be assembled with the indicator retaining feature 120. In some embodiments, the indicator 200 fits tightly with the indicator retaining feature 120, such that there is virtually no play (i.e., no relative movement) between the two parts. In some embodiments, the fit is more relaxed, such that the indicator 200 is permitted to move slightly with respect to the indicator retaining feature 120, while still being securely retained.

Indicators according to the present disclosure are described in more detail elsewhere in the specification.

In the embodiment shown, the indicator retaining feature 120 is recessed within the gripping surface 110, and the indicator 200 is retained within the recess. In such embodiments, a radially outer surface of the indicator 200 (when assembled within the indicator retaining feature 120) may be recessed within (as shown in the appended figures), flush with, or proud of the gripping surface 110.

In other embodiments (not shown), the indicator retaining feature 120 is proud of the gripping surface 110. For example, the indicator retaining feature 120 may comprise a ridge located on the gripping surface 110 that is swept along the retaining feature trajectory 130. In such embodiments, the indicator 200 would comprise corresponding features to permit retention with the proud indicator retaining feature 120 (e.g., a groove within a radially inner surface of the indicator 200 shaped to fit over the ridge).

In the exemplary embodiment shown in FIG. 2, the retaining feature trajectory 130 comprises an incomplete circular path, wherein a gripping surface position indicator 160 is located in the remaining portion of the circle (i.e., the uncompleted portion), or in whatever space separates the first retainer end 140 from the second retainer end 150. The gripping surface position indicator 160 indicates to the user the angular position of the rotatable control knob 100. Where a face surface position indicator 109 is also provided, the gripping surface position indicator 160 and the face surface position indicator 109 are preferably in angular alignment with one another. In doing so, the user is able to note the angular position of the rotatable control knob 100 from multiple angles.

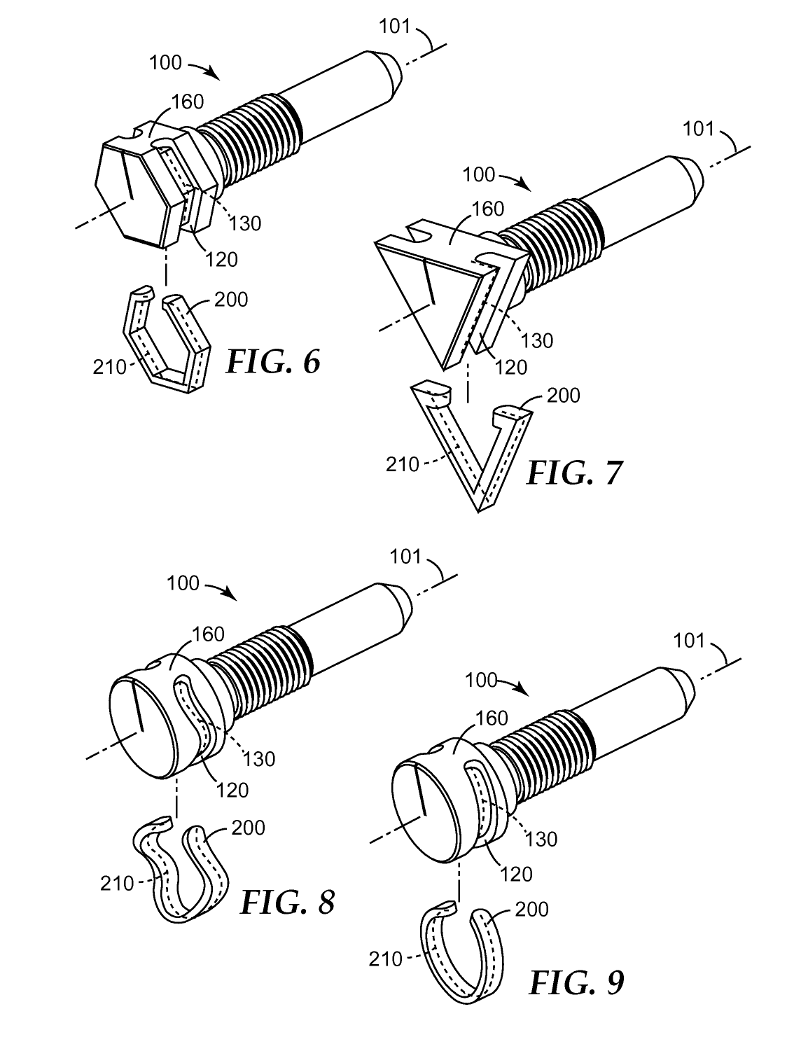

Turning now to FIG. 4, an exemplary rotatable control knob 100 is shown in cross-section, as viewed from the direction of the face surface 108 indicated in FIG. 3. As can be seen, and angle α separates the first retainer end 140 from the second retainer end 150. Therefore, the angular sweep of the retaining feature trajectory 130 can be represented by: (360°—angle α). Generally, the angular sweep of the indicator trajectory 210 will correspond to the angular sweep of the retaining feature trajectory 130. It should be understood that, although 360 degrees is referred to above, a circular (or cylindrical) shape is not required. For example, the hexagonal and triangular shapes as shown in FIGS. 6 and 7 are not circular, but are nevertheless swept through an angle of 360 degrees about the rotation axis 101, such that they form an enclosed polygon.

The size of the gripping surface position indicator 160 can be determined by the angle α. The angle α should be small enough that the indicator 200 wraps sufficiently around the gripping surface 110 to be securely retained. Conversely, the angle α should be large enough to provide an adequately sized gripping surface position indicator 160. In one embodiment, the gripping surface position indicator 160 spans an angle α about the rotation axis 101, wherein α is in a range from about 5° to about 90°, including 8°, 18°, 28°, 35°, 48°, 62°, or even 71°. In one embodiment α is in a range from about 10° to about 45°. In one embodiment α is in a range from about 25° to about 35°.

In some embodiments, the angle α may be made even smaller—even 0 degrees—so long as provision is made for a gripping surface position indicator 160. For example, the retaining feature trajectory 130 could be provided in a helical path (e.g., similar to FIG. 9) whereby the first retainer end 140 and the second retainer end 150 are present at the same angular position about the rotation axis 101, but are separated axially along the rotation axis 101. In such cases, the gripping surface position indicator 160 can be provided visually by the portion of gripping surface 110 spanning the axial distance between the first retainer end 140 and the second retainer end 150.

The gripping surface 110, the retaining feature trajectory 130, and the indicator trajectory 210 may be provided in alternate forms. By way of example, FIGS. 6-9 depict various possible shapes of each. Features from these exemplary embodiments can be mixed. For example, the hexagonal trajectory depicted in FIG. 6 could be modified to have an axial component (i.e., be made helical) as shown in FIG. 9.

As can be seen, for example, in FIGS. 5-9, the indicator 200 comprises a first indicator end 220 and a second indicator end 230 that are spaced apart from on another (i.e., the indicatory trajectory forms a discontinuous shape). This configuration, (when provided with a similarly discontinuous indicator 200 retainer feature) can provide multiple benefits. For example, in an embodiment wherein the gripping surface 110 is cylindrical, the discontinuous shape of the indicator 200 and the indicator retaining feature 120 prevents the indicator 200 spinning with respect to the indicator retaining feature 120. In doing so, the indicator 200 will not slip on the rotatable control knob 100 as the user tries to turn the knob. Moreover, regardless of the shape of the gripping surface 110, the gripping surface position indicator 160 is formed in the region of the discontinuity, thereby creating an additional visual cue as to the angular position of the rotatable control knob 100.

Indicators according to the present disclosure may be formed from any material that is sufficiently resilient to permit installation and retention with respect to the indicator retaining feature 120. For example, the indicator 200 may need to be “opened” to fit over the gripping surface 110 and then “released” to conform to the indicator retaining feature 120. Suitable materials may include resilient plastics and metals such as spring steel, etc. In one embodiment, a plurality of indicators of multiple colors (i.e., each a different color) is provided. In this way, each rotatable control knob 100 can be provided with an indicator 200 of a particular color.

By way of example, if a kit 300 is provided comprising a spray gun 10 according to the present disclosure having two rotatable control knobs (K1 and K2), along with indicators of four colors (R (red), G (green), Y (yellow), and B (blue)), the following 16 coding options are possible:

TABLE 1

| | | | | | | | | | | | | | | | | |
|---|---|---|---|---|---|---|---|---|---|---|---|---|---|---|---|---|
| K1 | R | R | R | R | G | G | G | G | Y | Y | Y | Y | B | B | B | B |
| K2 | R | G | Y | B | R | G | Y | B | R | G | Y | B | R | G | Y | B |

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

1. A spray gun comprising a rotatable control knob, the rotatable control knob comprising:
a gripping surface at least partially surrounding a rotation axis;
an attachment end disposed along the rotation axis for rotatable connection of the control knob to the spray gun;
an indicator retaining feature on the gripping surface extending in a retaining feature trajectory about the rotation axis from a first retainer end to a second retainer end; and
a gripping surface position indicator separating the first retainer end from the second retainer end, the gripping surface position indicator indicating the rotational position of the control knob about the rotation axis.

2. The spray gun of claim 1, wherein the gripping surface position indicator spans an angle α about the rotation axis, wherein α is in a range from about 5 degrees to about 90 degrees.

3. The spray gun of claim 1 wherein the retaining feature is recessed in the gripping surface.

4. The spray gun of claim 1 wherein the retaining feature is proud of the gripping surface.

5. The spray gun of claim 1 further comprising a face surface disposed along the rotation axis opposite the attachment end; and
a face surface position indicator aligned with the gripping surface position indicator.

6. The spray gun of claim 1 wherein the gripping surface is generally cylindrical.

7. The spray gun of claim 1 wherein the retaining feature trajectory sweeps an incomplete portion of a circular path, wherein the remaining portion of the circular path comprises the gripping surface position indicator.

8. The spray gun of claim 1 comprising an indicator retained by the indicator retaining feature.

9. The spray gun of claim 8 wherein the indicator is retained by the indicator retaining feature such that the indicator is retained against rotation with respect to the rotatable control knob.

10. The spray gun of claim 8 wherein the indicator comprises a color selected from a set of colors to color-code the spray gun.

11. The spray gun of claim 8 wherein the indicator comprises an indicator trajectory that corresponds to the retaining feature trajectory.

12. The spray gun of claim 8 wherein the indicator comprises a first indicator end and a second indicator end connected by an indicator body portion, and separated from one another by the gripping surface position indicator.

13. The spray gun of claim 12 wherein the first indicator end is positioned proximate the first retainer end, and the second indicator end is positioned proximate the second retainer end.

14. A kit comprising a spray gun according to claim 1 and one or more indicators adapted to be retained by the indicator retainer feature.

15. The kit of claim 14 comprising a plurality of indicators of different colors to enable a user to color-code the spray gun.
